(19) United States
(12) Patent Application Publication
(10) Pub. No.: US 2004/0038016 A1
(43) Pub. Date: Feb. 26, 2004

(54) Fiber reinforced resin articles and method of manufacturing same

(76) Inventors: Naohiro Morozumi, Iwata-shi (JP); Yasuo Suzuki, Iwata-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/601,412

(22) Filed: Jun. 23, 2003

(30) Foreign Application Priority Data
Jun. 21, 2002 (JP) 2002-180688
Jun. 18, 2003 (JP) 2003-173163

(51) Int. Cl. B32B 31/04; D04H 1/00

(52) U.S. Cl. 428/292.1; 264/258

(57) ABSTRACT

Prefabricated multi-layered mats of reinforcement fiber can be overlapped and saturated with resin so as to form a fiber-reinforced article. The overlapped portions can be modified so as to improve the flow of resin between the mats.

### PRIORITY INFORMATION

This application is based on and claims priority to Japanese Patent Application Nos. 2002-180688 filed Jun. 21, 2002, 2003-173163 filed Jun. 18, 2003, the entire contents of both of which is hereby expressly incorporated by reference.

### BACKGROUND OF THE INVENTIONS

1. Field of the Inventions

The present application generally relates to fiber reinforced articles. More specifically, the present application relates to articles, and methods for manufacturing articles with multi-layer fibrous mats.

2. Related Art

A wide variety of articles are made from a material consisting of fiber reinforced plastic, commonly known as fiberglass. Fiberglass has been widely used in numerous types of applications, including automotive bodies, watercraft components, bath tubs, surfboards, etc. Typically, such fiberglass articles were manufactured in a process in which mats of woven fiberglass fabric were laid in a mold by hand. Then, a liquid resin was applied to the fiberglass mats. The resin was then allowed to harden, thereby forming a composite resin/fiber material. Using such a method, articles with complicated shapes required more labor to fit the fiberglass mats into place before the resin is applied.

Recently, other fiber reinforcing materials became available in a sheet configuration. For example, a material known as sheet molding compound (SMC) has been developed for producing articles which were previously handmade with a fiberglass/resin material. One advantage of certain SMC materials is that with the application of heat, the sheet can be softened and pressed with dies so as to form the SMC sheet into a final article shape such as the hull or deck of a boat, or a body of an automobile.

More recently, prefabricated multi-layered fiberglass mats have become commercially available which can be used in a die-molding technique similar to that used with SMC, but eliminating the need for the application of heat. For example, a multi-layered fiberglass sheet material is now commercially available under the tradename “MULTIMAT®” from Saint-Gobain.

One feature that makes a multi-layered fiberglass mat, such as a MULTIMAT®, more widely usable is that they can provide a channel for allowing liquid resin to flow through the mat and thereby saturate the fibers therein, while the mat is contained in a mold between two molding dies. For example, such mats can include two outer layers and an additional middle layer. The outer layers can be configured to provide a greater resistance to the flow of resin than the middle layer. Each of the outer layers of MULTIMAT® fiberglass mats are made from chopped fibers which are stitched together, thereby forming a fabric layer having a relatively high density. The inner layer is formed from woven fiberglass yarn, and thus provides less resistance to the flow of resin therethrough.

Additionally, such mats can provide enhanced elastic deformation so that an article with a complicated shape can be manufactured more easily with a die-molding process. For example, the presently commercially available MULTIMAT® products can provide up to about 60% elastic elongation without tearing. Thus, using a die-molding process, a MULTIMAT® can be pressed between dies of a molding apparatus, while under tension, so as to prevent excessive creasing or folding of the mat as it is deformed into the tortuous shape defined by the dies.

### SUMMARY OF THE INVENTIONS

One aspect of at least one of the inventions disclosed herein includes the realization that when the edges of multi-layer fibrous mats are overlapped with each other, the overlapping edges can be modified so as to improve the flow of resin through the overlapping edges, and thereby improve the integrity of the joint defined by the overlapping edges. For example, when it is desired to form a large article with a fiber reinforced plastic material, it is generally desirable to use a single piece of prefabricated fiber reinforcing fabric. However, certain large articles have a surface area that is larger than the available sizes of prefabricated fiber reinforcing fabric. Thus, when manufacturing certain large articles such as, but without limitation, boat hulls and decks, it is sometimes necessary to use more than one piece of prefabricated fiber reinforcing fabric to manufacture a single part.

FIGS. 1 and 1A illustrate schematically in section view, first and second prefabricated multi-layer fiber reinforcing fabric mats 10, 20 which have been overlapped. In the illustration, the first mat 10 includes an upper outer layer 12, a lower outer layer 14, and an inner layer 16. The outer layers 12, 14 are more tightly woven than the inner layer 16. Thus, resin will flow more readily through the inner layer 16 than through the outer layers 12, 14. The mat 20 includes an upper outer layer 22, a lower outer layer 24 and an inner layer 26. The layers 22, 24, 26 are constructed in the same manner as the layers 12, 14 16, respectively.

As noted above, for manufacturing large articles, it may be necessary to use more than one mat. Thus, in order to manufacture such an article, the mats 10 and 20 can be placed in a mold and overlapped with each other. It has been discovered that when such mats are overlapped with each other, as illustrated in FIG. 1, resin R does not flow well through the overlapped edges of the mats 10, 20. Thus, the overlapping edges of the mats 10, 20 do not form an optimal joint therebetween. Additionally, as shown in FIGS. 2 and 2A, it has been found that when the free edges of adjacent mats 10, 20 are abutted next to each other, a gap 30 is formed between the mats 10, 20 thus generating an unacceptable weakness in the article.

Thus, in accordance with another aspect of at least one of the inventions disclosed herein, a method is provided for manufacturing a fiber-reinforced article having at least first and second mats of fiber material. The method comprises overlapping edges of the first and second mats, modifying at least one of the overlapping edges so as to improve a flow of liquid from the first met to the second mats through the overlapping edges, applying a liquid to the first mat so as to cause the liquid to flow through the first mat, through the overlapping edges, and into the second mat, and causing the liquid to harden.

In accordance with a further aspect of at least one of the inventions disclosed herein, a fiber reinforced article comprises first and second mats of multilayered fiber reinforcing material. The mats have first and second edges respectively. The first and second edges are overlapped. A resin material is impregnated into the first and second mats. Additionally, at least one of the first and second edges include a modification to improve a flow of resin from the first edge to the second edge.

Another aspect of at least one of the inventions disclosed herein includes the realization that other portions of a multi-layered mat can be modified to improve the uniformity of the flow of resin through the mat. For example, where a multi-layered mat is configured to provide lower flow resistance through an inner layer, flow diversion members can be added to the mat so as to create flow channels through the mat. As such, a user can define preferred flow paths of the resin through the mat.

Thus, in accordance with yet another aspect of the at least one of the inventions disclosed herein, a method is provided for manufacturing a fiber-reinforced article having at least one multi-layered mat of fiber material. The method comprises placing the mat in a mold. Flow guiding members are applied to the mat. The mat and guiding members are pressed between dies of the mold. Finally, resin is moved into the mat.

In accordance with another aspect of at least one of the inventions disclosed herein, a fiber reinforced article comprises at least one mat multi-layered fiber reinforcing material. At least one flow guiding member is applied to the mat so as to define a modified flow path of liquid resin through the mat. Additionally, a hardened resin is impregnated into the mat.

### BRIEF DESCRIPTION OF THE DRAWINGS

These and other features, aspects and advantages of the present inventions are described below with reference to the drawings of a preferred embodiment, which embodiment is intended to illustrate and not to limit the inventions, and in which figures:

FIG. 1 is a schematic sectional view of overlapping edges of two multi-layered fiber reinforcement mats, illustrating a deficiency in a technique for manufacturing an article by overlapping the edges of the mat;

FIG. 1A is another schematic sectional view of the overlapped mats illustrated in FIG. 1, schematically showing more detail of the layers of the mats;

FIG. 2 is a schematic sectional view of the mats illustrated in FIG. 1 arranged in an abutting relationship, and illustrating a drawback of these arrangements;

FIG. 2A is another schematic sectional view of the arrangement of the mats illustrated in FIG. 2 arranged in an abutting relationship, schematically showing more detail of the layers of the mats;

FIG. 3 is a top plan view of an upper deck portion of a personal watercraft;

FIG. 4 is a port side elevational view of the deck illustrated in FIG. 3;

FIG. 5 is a schematic illustration of a molding apparatus used for molding a fiber reinforcement sheet and injecting resin R into the mold, wherein the dies of the mold are illustrated in an open state;

FIG. 6 is a partial sectional view of the mold apparatus illustrated in FIG. 5 with the dies of the mold in an engaged state with the fiber reinforcement mat disposed between the dies;

FIG. 6A is a schematic illustration of two overlapped mats positioned over a lower die of the dies illustrated in FIG. 6;

FIG. 7 is a schematic sectional view of two fiber reinforcement mats having overlapped edges which have been modified in accordance with an aspect of at least one the inventions disclosed herein and illustrating a flow of resin through the overlapped edges;

FIG. 7A is another schematic sectional view of the two fiber reinforcement mats illustrated in FIG. 7, schematically showing more detail of the layers of the mats in one preferred arrangement;

FIG. 7B is a schematic perspective view of the two fiber reinforcement mats illustrated in FIG. 7A, schematically showing more detail of the layers of the mats;

FIG. 7C is another schematic sectional view of the two fiber reinforcement mats illustrated in FIG. 7, schematically showing more detail of the layers of the mats in another preferred arrangement;

FIG. 7D is a schematic perspective view of the two fiber reinforcement mats illustrated in FIG. 7C, schematically showing more detail of the layers of the mats;

FIG. 8 is a schematic sectional view illustrating a modification of the overlapped edges of the reinforcement mats illustrated in FIGS. 7-7D;

FIG. 8A is another schematic sectional view of the mats illustrated in FIG. 8, schematically showing more detail of the layers of the mats in one preferred arrangement;

FIG. 8B is a schematic perspective view of the mats illustrated in FIG. 8A;

FIG. 9 is a schematic and sectional view of yet another alternative of the modification of the overlapped edges of the reinforcing mats;

FIG. 9A is another schematic sectional view of the overlapped mats shown in FIG. 9, schematically showing more detail of the overlapped edges of the mats;

FIG. 9B is a schematic perspective view of the overlapped mats shown in FIG. 9A;

FIG. 10 is a schematic plan view of a fiber reinforcing mat having flow diversion members;

FIG. 11 is a schematic sectional view of the mat shown in FIG. 10, taken along line 11-11;

FIG. 12 is a schematic plan view of a different portion of the mat shown in FIG. 10;

FIG. 13 is a schematic perspective view of the portions of the mat shown in FIGS. 10-12, wherein the portion of FIGS. 10 and 11 is illustrated in a generally horizontal position and the portion of FIG. 12 is illustrated in a generally vertical position; and

FIG. 14 is a schematic perspective view of the mat of FIGS. 10-13 laid in a lower portion of a mold die.

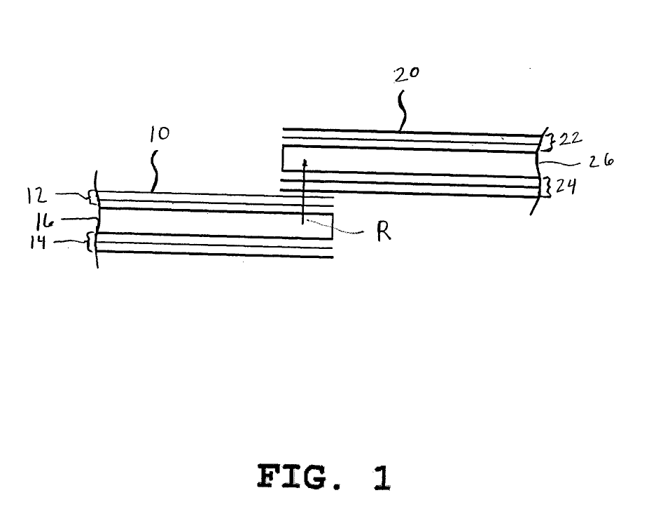

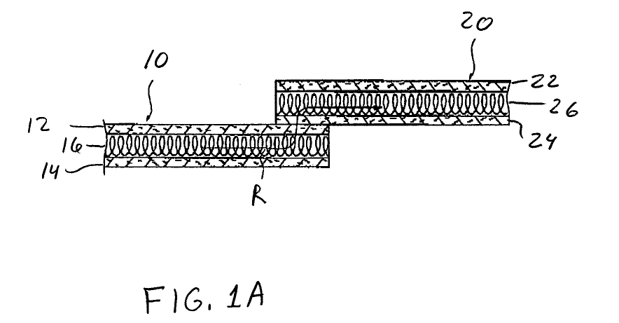

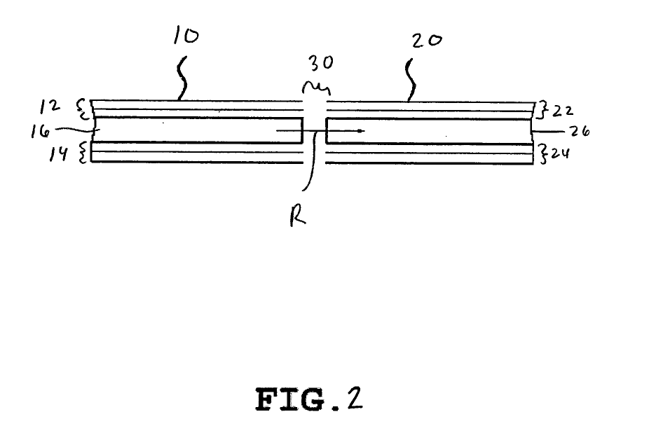

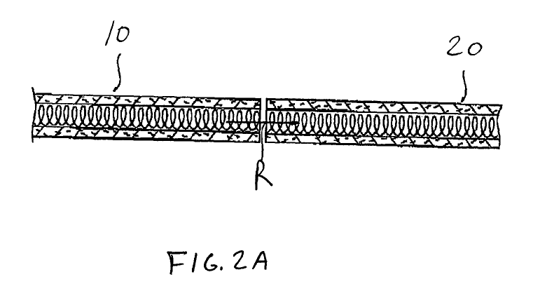

### DETAILED DESCRIPTION OF THE PREFERRED EMBODIMENTS OF THE INVENTIONS

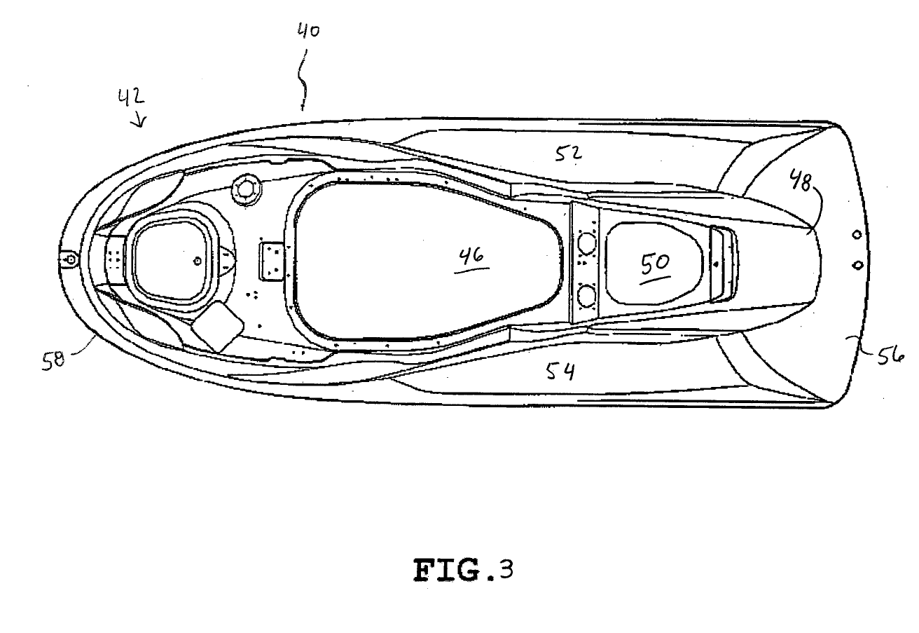

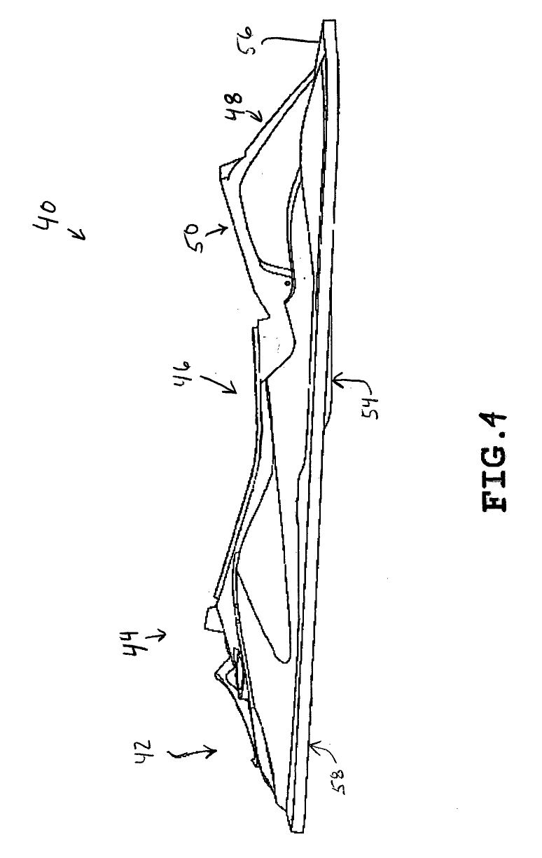

With initial reference to FIGS. 3 and 4, an upper deck section of a personal watercraft is described below solely for the purpose of describing one preferred use of the inventions disclosed herein. Of course, the inventions can be used in numerous other environments including, for example, but without limitation, the lower hulls of watercraft, automotive bodies, larger boats, building construction materials, etc.

The upper deck section 40 defines a bow portion 42 which extends upwardly and rearwardly toward a control mast support 44. An access opening 46 is disposed rearwardly from the control mast support 44.

Additionally, the upper deck 40 defines a pedestal 48 which is configured to support a seat (not shown). The pedestal 48 includes another access opening 50 disposed rearwardly from the access opening 46.

As shown on FIG. 3, the upper deck 40 also defines foot areas 52, 54 disposed on opposite sides of the pedestal 48. Thus, when a seat is mounted on the pedestal 48, riders can place their feet in the foot areas 52, 54. Additionally, the upper deck 40 defines a rear deck area 56 which provides an area for mounting the corresponding watercraft from the rear.

A flange 58 extends around the periphery of the deck 40. The flange is configured to mate with a corresponding flange on a lower hull portion of a watercraft having the deck 40. These flanges are bonded together so as to define an internal cavity in which an engine is typically supported.

The upper deck section 40 includes various other apertures and mounting surfaces. However, the precise features of the upper deck portion 40 are not related to the inventions disclosed herein and thus further details regarding the upper deck section 40 are not described in any further detail. It is significant to note that the upper deck section 40 illustrated in FIG. 3 can be manufactured as a single monolithic component. Where the upper deck section 40 is made as a single monolithic component, the manufacturing methods as described below with reference to the remaining figures can be used to manufacture the upper deck section 40. Alternatively, the same manufacturing process described below can be used to form individual components of the upper deck section 40 which are then connected to form the illustrated upper deck section 40.

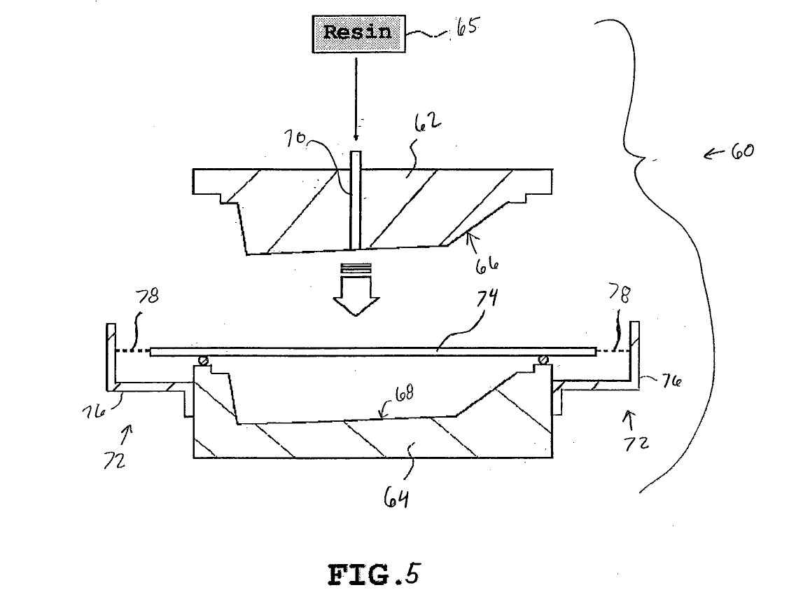

FIG. 5 schematically illustrates a molding apparatus 60 which includes first and second die assemblies 62, 64 and a resin R supply 65. The first and second die assemblies 62, 64 include molding surfaces 66, 68, respectively. The molding surfaces 66, 68 are shaped so as to correspond to the upper and lower surfaces of the deck portion 40, respectively.

The upper die assembly 62 includes a resin R delivery port 70. The resin R delivery port 70 is defined as a channel extending through the die assembly 62. The channel is configured to guide resin R from the resin R source 66 into a space between the guide assembles 62, 64 when they are pressed into a mating relationship, described below in greater detail. It is to be noted that the upper die assembly 62 can include a plurality of resin delivery ports 70. Additionally, the resin delivery port 70 can be disposed in the lower die assembly 64. Further, both the first and second die assembly 62, 64 can include one or a plurality of resin delivery ports 70.

Preferably, the molding apparatus 60 includes a tensioning system 72. The tensioning system 72 is configured to generate tension in a component 74 which is to be molded in the molding apparatus 60 along with resin from the resin source 66. In the illustrated embodiment, the member 74 is a fiber reinforcement mat. The tensioning system 72 includes a bracket 76 mounted to the second die assembly 64. This arrangement is merely one exemplary and non-limiting arrangement. The bracket 76 can be attached to any other device including the first die assembly 62 or other members which remain stationary relative to one of the die assemblies 62, 64.

The tensioning system 72 also includes a tensioning member 78. Preferably, there are a plurality of brackets 76 and tensioning members 78 disposed around the periphery of one of the die assemblies 62, 64. The tensioning member 78 can be in the form of any type of device that can be configured to provide tension to the member 74. For example, but without limitation, the tensioning members can be springs.

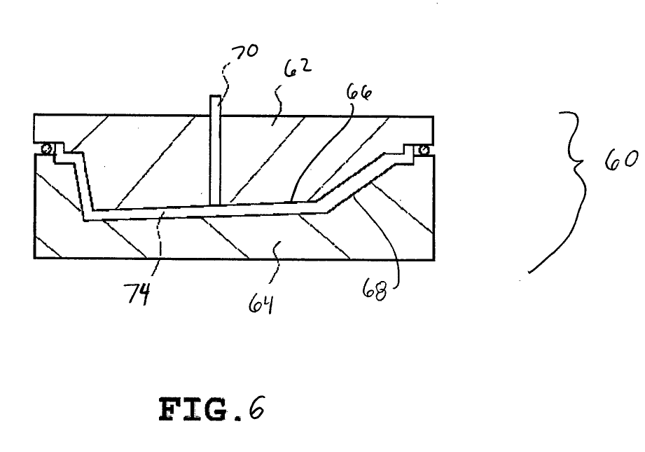

FIG. 6 illustrates a state of the molding apparatus 60 in which the first and second die assemblies 62, 64 have been pressed together in a mating relationship, thereby deforming the member 74 into the tortuous shape corresponding to the shape of the upper deck section 40 (FIGS. 3 and 4). With the first and second die assemblies 62, 64 pressed together in the mating relationship illustrated in FIG. 6, resin is then injected into the space between the molding surfaces 66, 68 under pressure or is drawn into the member under vacuum. As such, the element 74 becomes impregnated with the resin. This process is known as a resin transfer molding (RTM) technique.

Where the element 74 is formed from a multi-layered mat of reinforcing fiber in which the outer layers provide a greater resistance to the flow of liquid resin than the inner layer(s), the resin tends to flow through the inner layer more quickly. As the process continues, the resin gradually flows into the outer layers, thereby impregnating the outer layers. Additionally, because the outer layers provide greater resistance to the flow of liquid resin, the pressure of the resin acts against the inner surfaces of the outer layers, thereby helping to keep the mat inflated during a molding procedure.

The resin impregnated element 74 is allowed to harden and is removed from the molding apparatus 60. After hardening, the resin impregnated element 74 remains in the form of the upper deck section 40 illustrated in FIGS. 3 and 4.

As noted above, the total surface area of the upper deck section 40 may be sufficiently large that the commercially available fiber reinforcement sheets are not large enough to form the upper deck section 40 with a single piece of fiber reinforcement sheet. Thus, the element 74 (FIGS. 5 and 6) can be made from multiple pieces of fiber reinforcement sheet. For example, FIG. 6A illustrates two multi-layered mats 10, 20 forming the element 74 and being laid over the mold die 64.

The construction of the layers 12, 14, 16, 22, 24, 26 of the mats 10, 20, respectively, are discussed above. Further, the construction of the mats 10, 20 can be in accordance with the description set forth in Japanese Patent Application 2002-120315 filed Oct. 17, 2000.

Generally, the features of the mats 10, 20 which can create difficulties joining two adjacent mats, such as the mats 10, 20, is that certain of the layers of the mats 10, 20 has a higher resistance to the flow of resin therethrough than another layer. For example, the layers 12, 14, 22, 24 have a higher resistance to the flow of resin therethrough than the resistance provided by the layers 16, 26.

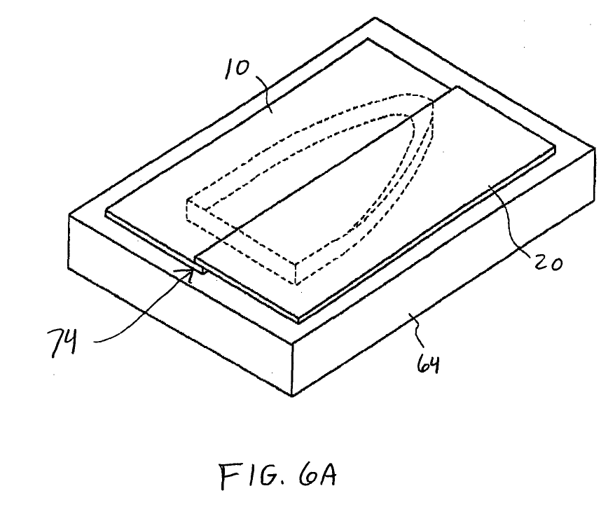

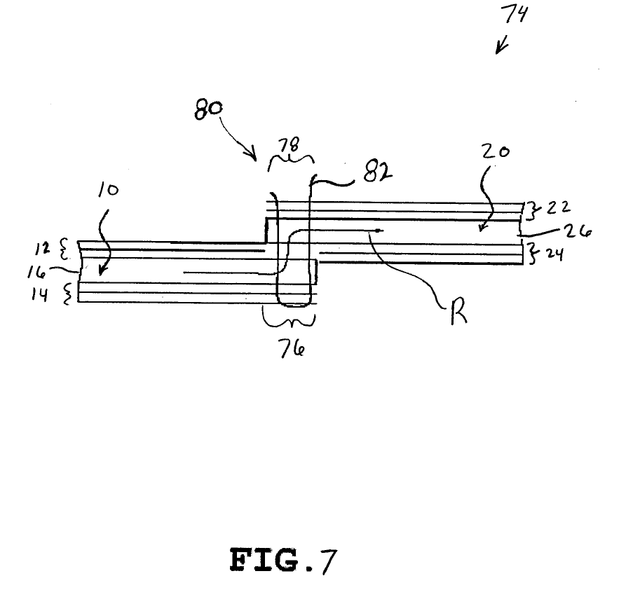

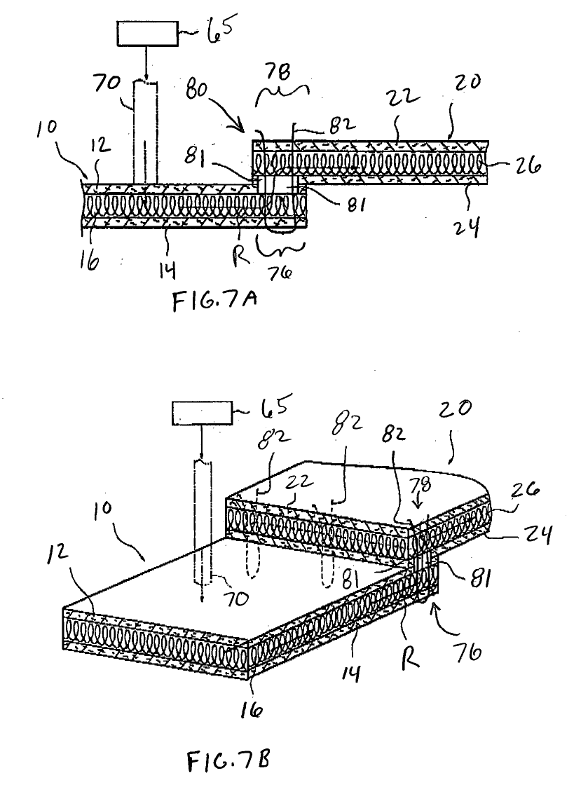

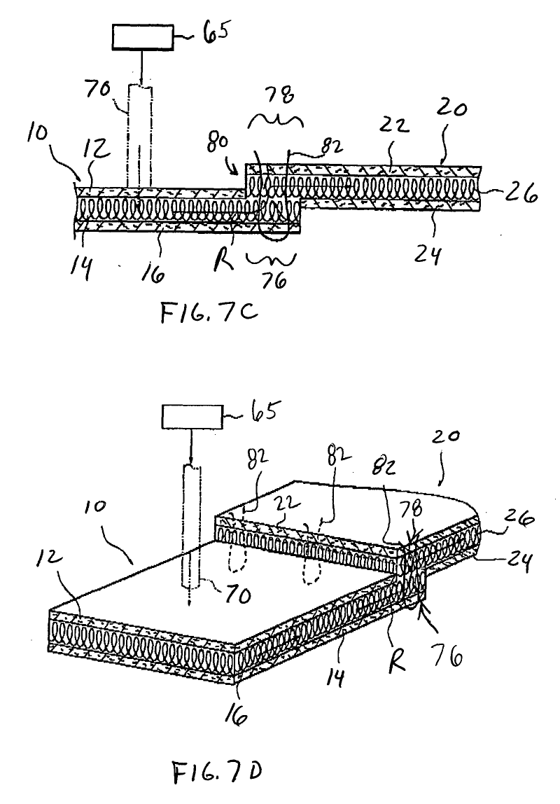

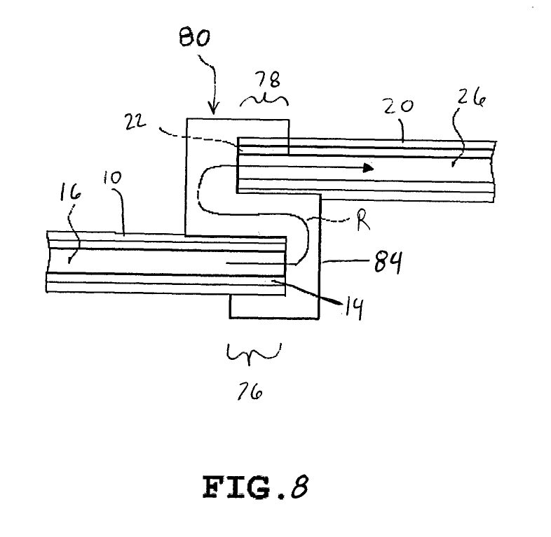

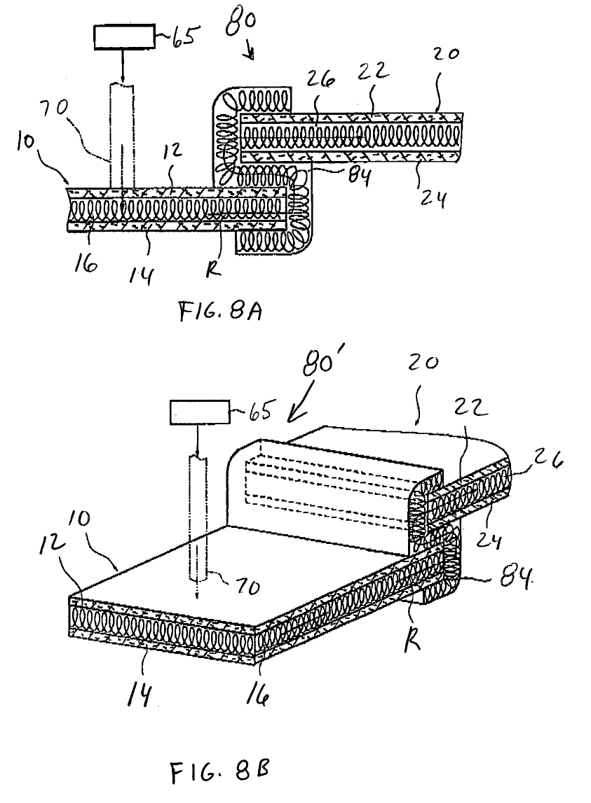

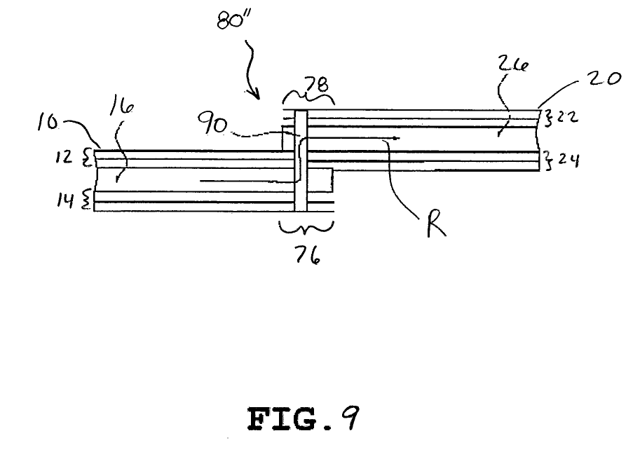

As shown in FIGS. 7, 7A, 7B, a portion 76 of the mat 10 is overlapped with a corresponding portion 78 of the mat 20. As noted above, because the layers 12, 24 provide a higher resistance to the flow of resin therethrough relative to the layers 16, 26, if the portions 78, 76 were overlapped with each other without any further modification, the flow of resin R through the overlapped portions 76, 78 would be insufficient. Thus, as illustrated in FIG. 7, the element 74 includes a modification 80 to improve the flow of resin through the overlapped portions 76, 78.

In the illustrated embodiment, the modification can comprise a gap 81 formed in at least one of the layers 12, 24 of the overlapped portions 76, 78. In this embodiment, the gap 81 is defined as a channel or groove extending along overlapped portions 76, 78, in the vicinity of the edge of the mats 10, 20.

In an illustrative but non-limiting example, a portion of at least one of the layers 12, 24 can be crushed or cut away prior to overlapping portions 76, 78. As noted above, the layers 12, 24 have a higher resistance to the flow of resin R therethrough. Thus, by removing a portion of at least one of layers 12, 24, to form a gap 81, the flow of resin R through the overlapped portions 76, 78 improves, thereby enhancing the strength of the finished article at the overlapped portions 76, 78. FIGS. 7A and 7B illustrate a preferred arrangement in which the modification 80 comprises the gaps 81 formed in both of the layers 12, 24.

A further improvement is provided where the modification 80 includes stitches 82 extending through the overlapped portions 76, 78. It has been found that by using stitches 82 through the overlapped portions 76, 78, these portions 76, 78 can be compressed against each other to further enhance the flow of liquid resin therethrough. Further, the mats 10, 20 can be joined together in a predetermined arrangement so that the joined mats can be quickly placed in the molding device 60 (FIGS. 5 and 6) when a molding procedure is to begin.

FIGS. 7D and 7C illustrate another preferred arrangement in which the gaps 81 extend to the free edge of the mats 10,20. Thus, in this modification, the inner layers 16, 26 contact each other, providing further enhanced flow of resin R. Additionally, the stitches 82 can be eliminated, wherein the gaps 81 provide the enhanced flow of resin between the mats 10, 20.

With reference to FIGS. 8, 8A, and 8B, an alternate version of the modification 80 is illustrated therein, and referred to generally by the reference numeral 80′. In the illustrated embodiment, the modification 80′ includes a connector mat 84. The connector mat 84 can be made from the same material as the mats 10, 20. Alternatively, the connector mat 84 can be formed of a mat made from the material used to form the inner layers 16, 26.

The connector mat 84 preferably is wrapped around the free edge of the mat 10 forming the overlapped portion 76 and around the free edge of the mat 20 which forms the overlapped portion 78. As a result, the connector mat 84 extends through a serpentine path around the free edges of the mats 10, 20.

It has been found that by using a connector mat 84 as such, the flow of resin R can be guided from the end of the layer 16 of the mat 10 into the inner layer of the connector mat 84, then into the inner layer 26 of the mat 20, thereby improving the flow of resin R from the mat 10 to the mat 20.

Optionally, the connector mat 84 can be modified to further enhance the flow of resin therethrough. For example, as noted above, the connector mat 84 can be formed from the same material as the mats 10, 20. As such, the connector mat 84 has two outer layers and an inner layer, wherein the outer layers provide a higher resistance to the flow of resin R than that provided by the inner layer. Thus, in one modification, a portion of the outer layer in the vicinity of the end of the inner layer 16 of the mat 10 can be modified or removed so as to improve the flow of resin from the inner layer 16 into the inner layer of the connector mat 84. Similarly, a portion of an outer layer of the connector mat 84 in the vicinity of the end of the layer 26 of the mat 10 can be modified or removed so as to improve the flow of resin from the inner layer of the connector mat 84 into the inner layer 26 of the mat 20. As such, the flow of resin R into and out of the connector mat 84 is further improved.

In another preferred arrangement, the connected mat 84 is formed only of a single layer of fiber reinforcement. In this arrangement, as noted above, the connector mat is formed from the same material used to form the inner layers 16, 26. As such, the flow of resin between the mats 10, 20 is further enhanced.

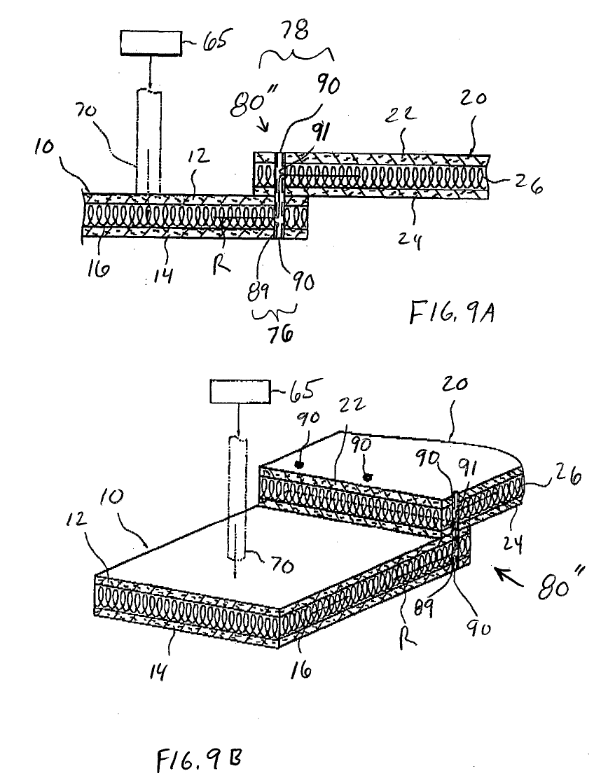

With reference to FIGS. 9, 9A, and 9B, another alternative to the modification 80 is illustrated therein and referred to generally by the reference numeral 80″. In the illustrated embodiment, the modification 80″ includes a passage 90 extending through the layers 12, 14.

The passage 90 can be defined as a hole punched through the overlapping portions 76, 78. Alternatively, the passage 90 can be defined by a tube inserted into the overlapped portions 76, 78. For example, a tube having a central lumen and at least one hole 89 communicating with the layer 16 and the second hole 91 communicating with the layer 26 can improve the flow of resin R through layers 12, 24.

Optionally, the passage 90 can be formed from a porous material configured to allow resin R to seep into the material and thereby define a resin conduit through the layers 12, 24. The size and the porosity of the porous member can be determined through routine experimentation in order to provide a satisfactory flow of the resin R through the layers 12, 24. In another alternative, the passage 90 can be formed from a fibrous rod, providing a plurality of longitudinal passages therethrough and having openings aligned with at least the inner layers 16 and 26.

A further advantage is provided where the passage 90 comprises a flexible member. As such, when the passage 90 is pressed between the dies of a mold, the passage 90 is less likely to be damaged. For example, the passage 90 can be deformed by the dies. However, the portion of the passage 90 extending from the layer 16 to the layer 26 can remain in place.

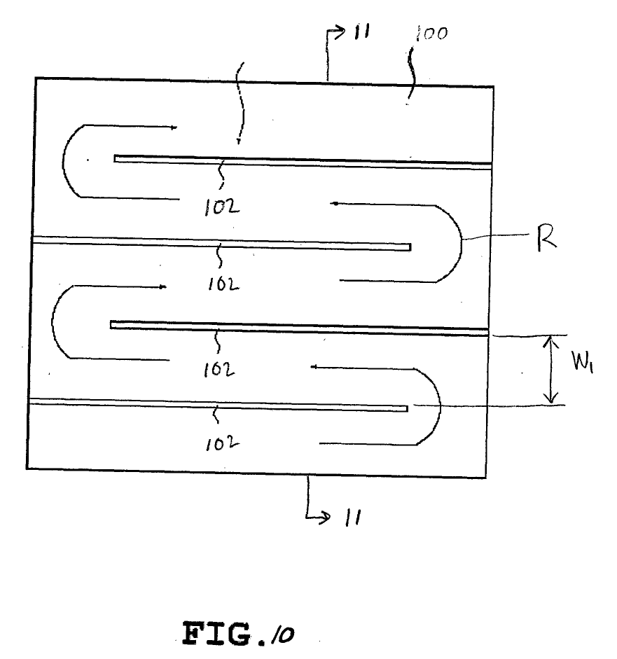

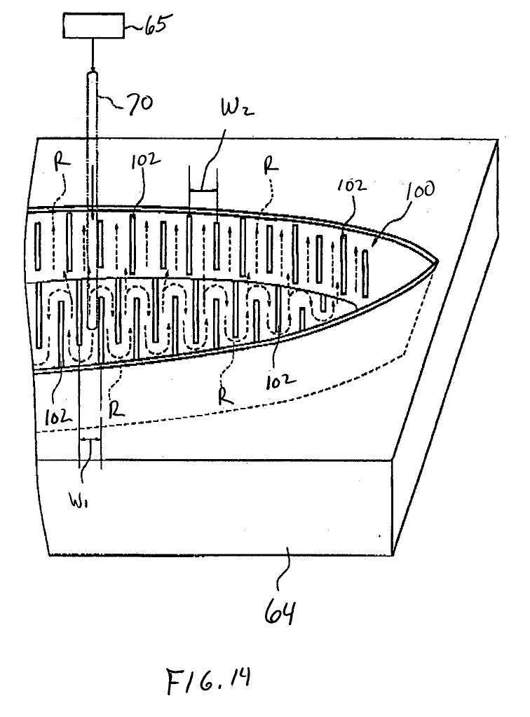

With reference to FIGS. 10 and 14, another aspect of at least one of the inventions disclosed in the present application is directed to enhancing the uniformity of the flow of resin R through a mat. FIG. 10 schematically illustrates a mat 100 and the plurality of flow-guiding members 102 which are arranged to define a modified flow path for resin R flowing therethrough.

For example, the mat 100 can be a multi-layer mat constructed in accordance with the description set forth above with reference to the mats 10 and 20. The flow guide members 102 can be constructed from any type of material. Preferably, the guide members 102 are formed from the same material used to form the mat 100. Thus, for example, but without limitation, the flow guide members 100 can be formed from fiberglass yarn, strings, or rods sized so as to interfere with the flow of resin R through a central layer of the mat 100. Thus, as the resin flows through the mat 100, the flow guide members 102 interfere with the flow of resin therethrough, thereby redirecting the flow of resin R.

As illustrated in FIG. 10, the flow guide members 102 can be offset from one another, thereby forming a labyrinth path. The flow guide members 102 are arranged generally parallel to one another and spaced at a spacing W₁.

The spacing of the guide members 102 can be any distance. However, desired or optimum spacing can be determined through routine experimentation.

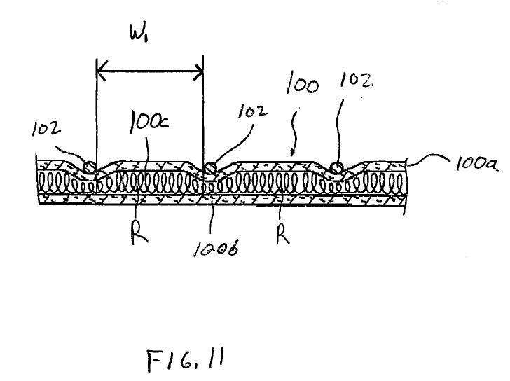

FIG. 11 illustrates one configuration of the guide members 102 for guiding the flow of resin, as described above with reference to FIG. 10. The mat 100 illustrated in FIG. 11 includes outer layers 100a and 100b. The inner layer of mat 100 is identified by the reference numeral 100c.

As shown in FIG. 11, the guide members 102 can be placed on the exterior of the mat 100, against one of the other layers 100a, 100b. Thus, when the mat 100 is pressed in a mold with dies, the guide members 102 compress a portion of the mat 100 which thereby restricts flow of resin R past the guide member 102.

For example, as illustrated in FIG. 11, the guide members 102 can be sized so as to pinch the mat 100 sufficiently to compress the inner layer 100c. Thus, in the areas where the guide members 102 are disposed, the flow of resin through the inner layer 100c is restricted. Thus, the guide members 102 can redirect a flow of the resin R through the inner layer 100c. The guide members 102 can remain in the mat 100 throughout the molding process, and thus become part of the finished article.

The guide members 102 can be constructed such that they remain intact after the dies 62, 64 are initially brought together and during a resin impregnation procedure. Optionally, the guide members 102 can be constructed with sufficient brittleness such that they can be ruptured after the resin has been fully introduced into the mat 100, by applying further pressure to the dies 62, 64. This provides a further advantage in reducing the likelihood that the guide member 102 might cause a visual or tactile imperfection in the surface of the finished article.

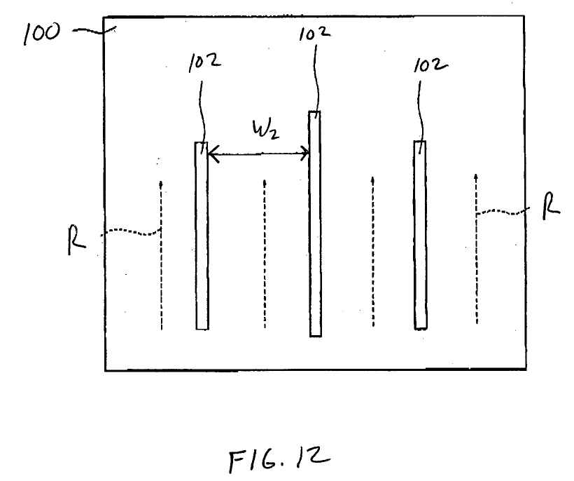

FIG. 12 illustrates schematically a portion of the mat 100 which is disposed generally vertically within a mold. As shown in FIG. 12, the guide members 102 can be arranged generally vertically to help direct a flow of the resin R upwardly into a vertical piece of the mat 100. In this figure, the spacing of the members 102 is defined as W₂.

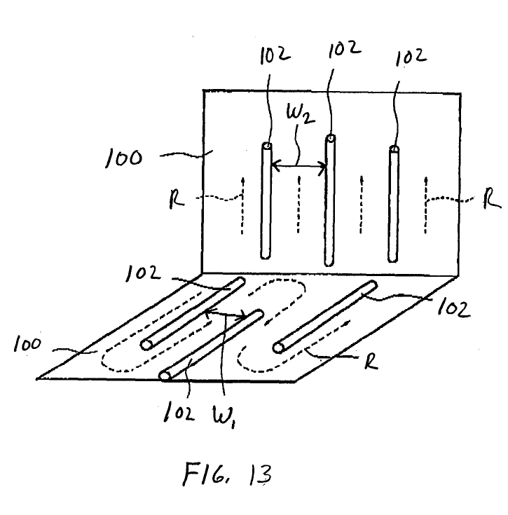

FIG. 13 schematically illustrates an arrangement in which the mat 100 includes a plurality of guide members 100 on a lower, generally horizontal portion of the mat 100, and another portion of the mat 100 which extends generally vertically through a vertical portion of a mold. As schematically shown on FIG. 13, the spacing W₁ of the guide members 102 and the generally horizontal part of the mat 100 is smaller than the spacing W₂ of the guide members 102 in the vertical portion of the mat 100.

FIG. 14 illustrates a mat 100 having been laid in a mold die such as the mold die 64 which is configured to form a portion of the watercraft such as the lower hull portion. The portion of the mat 100 forming the lower surface of the hull includes guide member 102 in accordance with the description set forth above with reference to FIG. 10. The portion of the mat 100 forming the generally vertical sidewalls of the hull includes guide members 102 spaced and arranged in accordance with the description set forth above with reference to FIGS. 12 and 13.

FIG. 14 also illustrates that the guide members can be aligned such that resin flows through the labyrinth defined by the guide members 102 on the lower portion of the mold, and additionally the flow of resin R can branch off of the flow through the labyrinth and flow upwards between the vertically arranged guide members 102. As such, the uniformity of the flow of resin R through the mat 100 can be further enhanced.

Although the present inventions have been described in terms of a certain embodiments, other embodiments apparent to those of ordinary skill in the art also are within the scope of these inventions. Thus, various changes and modifications may be made without departing from the spirit and scope of the inventions. For instance, various components may be repositioned as desired. Moreover, not all of the features, aspects and advantages are necessarily required to practice the present inventions. Accordingly, the scope of at least one of the present inventions are intended to be defined only by the claims that follow.

What is claimed is:

1. A method of manufacturing a fiber-reinforced article having at least first and second mats of fiber material, the method comprising overlapping edges of the first and second mats, modifying at least one of the overlapping edges so as to improve a flow of liquid from the first met to the second mats through the overlapping edges, applying a liquid to the first mat so as to cause the liquid to flow through the first mat, through the overlapping edges, and into the second mat, and causing the liquid to harden.

2. The method according to claim 1, wherein modifying comprises removing at least a portion of an outer layer of one of the first and second mats in the vicinity of the overlapping edges.

3. The method according to claim 1, wherein modifying comprises removing an outer layer of portions of both the first and second mats which define the overlapping edges.

4. The method according to claim 1, wherein modifying comprises removing a strip of an outer layer of both of the first and second mats, so as to define first and second channels in the first and second mats.

5. The method according to claim 4, wherein the step of overlapping edges comprises positioning the first and second channels to face each other.

6. The method according to claim 1 additionally comprising stitching the overlapping edges together.

7. The method according to claim 1, wherein modifying comprises providing a passage extending from an inner layer of the first mat, through an outer layer of the first mat, through an outer layer of the second mat, and into an inner layer of the second mat.

8. The method according to claim 7, wherein providing a passage comprises inserting a tube through the overlapping edges.

9. The method according to claim 8, wherein inserting a tube comprises inserting a flexible tube through the overlapping edges and aligning a first aperture in the tube with the inner layer of the first mat, and aligning a second aperture of the tube with the inner layer of the second mat.

10. A method of manufacturing a fiber-reinforced article having at least one multi-layered mat of fiber material, the method comprising placing the mat in a mold, applying flow guiding members to the mat, pressing the mat and guiding members between dies of the mold, and moving resin into the mat.

11. The method according to claim 10 further comprising pressing the mat and guiding members with the dies until the at least one of the guide members ruptures.

12. The method according to claim 10, wherein applying comprises placing the flow guiding members on an outer layer of the mat, wherein the flow guiding members are sized so as to compress the mat sufficiently to restrict a flow of resin through the mat in the vicinity of the flow guiding members.

13. The method according to claim 10, wherein applying comprises forming a labyrinth flow path with the flow guiding members in a portion of the mat which extends generally horizontally.

14. The method according to claim 10, wherein applying comprises forming a vertical flow path with the flow guiding members in a portion of the mat which extends generally vertically.

15. The method according to claim 14, wherein applying further comprises forming a labyrinth flow path with the flow guiding members in a portion of the mat which extends generally horizontally and connecting the labyrinth flow path with the vertical flow path.

16. The method according to claim 10, wherein placing the mat in a mold comprises placing a mat having at least two outer layers and at least one inner layer, wherein the outer layers generate a higher resistance to a flow of resin than the inner layer.

17. A fiber reinforced article comprising first and second mats of multi-layered fiber reinforcing material, the mats having first and second edges respectively, the first and second edges being overlapped, a resin material impregnated into the first and second mats, wherein at least one of the first and second edges include a modification to improve a flow of resin from the first edge to the second edge.

18. The fiber reinforced article according to claim 17, wherein each of the first and second mats comprise at least two outer layers and at least one inner layer, the outer layers providing a higher resistance to a flow of liquid resin than the inner layer.

19. The fiber reinforced article according to claim 17, wherein the modification comprises a portion of an outer layer of the first edge having been removed.

20. The fiber reinforced article according to claim 19, wherein the modification comprises a portion of an outer layer of the second mat having been removed.

21. The fiber reinforced article according to claim 20, wherein the modification further comprises stitches extending through the overlapped first and second edges.

22. The fiber reinforced article according to claim 17, wherein the modification comprises a tube extending through the overlapped edges.

23. The fiber reinforced article according to claim 22, wherein the tube comprises a flexible member.

24. The fiber reinforced article according to claim 12, wherein the tube includes at least a first aperture exposed to an inner layer of the first mat and a second aperture exposed to an inner layer of the second mat.

25. A fiber reinforced article comprising at least one mat of multi-layered fiber reinforcing material, at least one flow guiding member applied to the mat so as to define a modified flow path of liquid resin through the mat, and a hardened resin impregnated into the mat.

26. The fiber reinforced article according to claim 25, additionally comprising a plurality of flow guiding members defining a labyrinth flow path for liquid resin.

27. The fiber reinforced article according to claim 26, wherein the labyrinth flow path extends through a portion of the mat which was generally horizontally extending when the resin was in a liquid form and was moved into the mat during a molding process.

28. The fiber reinforced article according to claim 25, additionally comprising a plurality of flow guiding members which defined a generally vertical flow path for liquid resin when the resin was in a liquid form and was moved into the mat.
